(19) United States
(12) Patent Application Publication
(10) Pub. No.: US 2025/0220797 A1
(43) Pub. Date: Jul. 3, 2025

(54) MATERIAL HANDLING CONTAINER WITH ELECTROSTATIC DISCHARGE PROTECTION

(71) Applicant: Schaefer Plastics North America, LLC, Charlotte, NC (US)

(72) Inventor: Ethan Robert Argetsinger, Charlotte, NC (US)

(21) Appl. No.: 18/284,237

(22) PCT Filed: Sep. 22, 2023
(86) PCT No.: PCT/US2023/074910

§ 371 Date: Sep. 26, 2023

Related U.S. Application Data
(60) Provisional application No. 63/377,241, filed on Sep. 27, 2022.

(51) Int. Cl. H05F 3/02; B65D 19/02; B65D 19/38

(52) U.S. Cl. CPC H05F 3/02; B65D 19/02; B65D 19/38

(57) ABSTRACT

A material handling container comprising a base, at least one sidewall coupled to the base, and an electrostatic discharge assembly integrated into the container. The electrostatic discharge assembly includes a first conductive device and a second conductive device in electrical communication with the first conductive device. The second conductive device is configured to cooperate with at least one of a ground and a first conductive device of an electrostatic discharge assembly of another container.

### CROSS-REFERENCE TO RELATED APPLICATION

This application is a United States 371 national stage application tracing priority to and claiming the benefit of Patent Cooperation Treaty (PCT) Application No. PCT/US2023/074910, filed on Sep. 22, 2023, entitled Material Handling Container with Electrostatic Discharge Protection, which traces priority to and claims the benefit of U.S. Provisional Patent Application Ser. No. 63/377,241, filed on Sep. 27, 2022, entitled Dunnage Container with Electrostatic Discharge Protection, the entire contents of both of which are hereby expressly incorporated herein by reference.

### FIELD

The disclosure relates to a container, and more particularly to a material handling container with electrostatic discharge protection.

### BACKGROUND

Reusable containers have become a practice in industry for several reasons. First, reusable containers are sturdy and provide a high level of protection to shipped items compared to the customary, corrugated fiberboard containers. Second, the lifetime cost per use is generally less for a reusable container. Third, environmental considerations weigh in favor of reusable containers which require less frequent replacement and offer various recycling options.

Return shipments of collapsible reusable containers to the originating shipper are more economical and efficient than non-collapsible units. Collapsing the container to a fraction of its erected size allows a denser load to be shipped, as it may cost no more to ship three to four times the number of collapsed containers than to ship a lesser number in an erected condition. This is particularly true if the freight charge is calculated, not by weight, but either on a truck load basis or on a set volume of freight.

A major problem with current collapsible containers, however, is a transfer of energy or a “charge” between bodies that have different electrostatic potentials. Components transported in containers with inadequate electrostatic discharge (ESD) protection are subject to catastrophic failure. Sometimes an ESD event can damage a component transported in the containers even though the component continues to function. Damage of this type constitutes latent defects, which are hard to detect and significantly shortens a life of the component.

A conventional container with ESD protection is a container injection molded using ESD material. The drawbacks of such design is cost and lead time to produce the containers. The ESD material can be quite costly. As such, the containers produced from the ESD material can cost three times more than a standard container. Moreover, the ESD material is difficult to injection mold, which also increases the cost of the container due to onerous manufacturability.

Another alternative currently employed today is to add a conductive chain to the standard container. The chain attaches to the container and drags on the ground allowing the energy to transfer from the container through the chain to the environment. One shortcoming of the chain is longevity. The chain is prone to inadvertent detachment along with damage and wear associated with being dragged on the ground. Additionally, the chain does not impart consistent grounding of the container. Since the chain uses gravity to maintain contact with the ground, there is always a risk that separation therebetween will occur, especially during transport. Further, when the containers are stacked upon each other, there is no guarantee that the chain will contact any surface that can ground the container without manual connection by an operator. Moreover, the manual connection is also dangerous since it typically requires the operator to be high off of the ground to connect all of the containers together.

Accordingly, it would be desirable to produce a container with electrostatic protection, which is easily manufactured and cost effective, yet efficient and durable.

### SUMMARY

In concordance and agreement with the presently described subject matter, a material handling container with electrostatic protection, which is easily manufactured and cost effective, yet efficient and durable, has been newly designed.

In one embodiment, an electrostatic discharge assembly for a container, comprises: at least one conductive device configured to be coupled to a container for electrical communication with a ground, wherein the at least one conductive device includes a rigid movable element configured to be in selective electrical communication with the ground.

In another embodiment, an electrostatic discharge assembly for a container, comprises: a first conductive device configured to be coupled to a container; and a second conductive device electrically connected to the first conductive device, and wherein the second conductive device is in selective electrical communication with a ground.

In yet another embodiment, a material handling container, comprises: a base; at least one sidewall coupled to the base; and an electrostatic discharge assembly integrated into at least one of the base and the at least one sidewall, the electrostatic discharge assembly comprises: a first conductive device; and a second conductive device electrically connected to the first conductive device, wherein the second conductive device is in selective electrical communication with a ground.

As aspects of some embodiments, the movable element is retractable to a position at least partially surrounded by at least a portion of the container.

As aspects of some embodiments, the movable element is a spring-loaded plunger.

As aspects of some embodiments, the movable element is configured for electrical communication with at least one conductive device of another container.

As aspects of some embodiments, the first conductive device is electrically connected to the second conductive device by a frame of the container.

As aspects of some embodiments, the electrostatic discharge assembly further comprises a connector to electrically connect the first conductive device to the second conductive device.

As aspects of some embodiments, the connector includes a first piece, a second piece, and an electrical jumper to selectively electrically connect the first piece and the second piece.

As aspects of some embodiments, the movable element is configured for electrical communication with a first conductive device of another container.

As aspects of some embodiments, the first conductive device is coupled to an upper portion of the at least one sidewall of the container.

As aspects of some embodiments, the second conductive device is coupled to a lower portion of the base of the container.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a material handling container according to an embodiment of the present disclosure, wherein the material handling container is provided with at least one electrical discharge assembly including first and second conductive devices;

FIG. 2 is an enlarged perspective view of a portion of the material handling container within Circle A of FIG. 1, showing the second conductive device of the electrical discharge assembly;

FIG. 3 is a perspective view of a pair of side frames of the material handling container of FIG. 1 according to an embodiment of the present disclosure, wherein each side frames is provided with the electrical discharge assembly;

FIG. 4 is an enlarged perspective view of the second conductive device shown within Circle B of FIG. 3;

FIG. 5 is an expanded perspective view of a container stack according to an embodiment of the present disclosure, wherein the container stack includes a plurality of the material handling containers of FIG. 1 shown in a stacked relationship;

FIG. 6 is a perspective view of the container stack of FIG. 5;

FIG. 7 is an expanded perspective view of a side frame stack according to an embodiment of the present disclosure, wherein the side frame stack includes a pair of the side frames of FIG. 3 in a stacked relationship with another pair of the side frames of FIG. 3;

FIG. 8 is a perspective view of the side frame stack of FIG. 7;

FIG. 9 is an elevational view of the side frame stack of FIGS. 7 and 8, wherein the side frame stack is in electrical communication with a ground;

FIG. 10 is a perspective view of a material handling container according to another embodiment of the present disclosure, wherein the material handling container is provided with an electrical discharge assembly including first and second conductive devices;

FIG. 11 is an enlarged fragmentary perspective view of a portion of the material handling container within Rectangle C of FIG. 10, showing the electrical discharge assembly;

FIG. 12 is a perspective view of a container stack according to an embodiment of the present disclosure, wherein the container stack includes a plurality of the material handling containers shown in FIG. 10;

FIG. 13 is an elevational view of the container stack of FIG. 12, wherein the container stack is in electrical communication with a ground;

FIG. 14 is a top perspective view of a material handling container according to another embodiment of the present disclosure, wherein the material handling container is provided with an electrical discharge assembly including first and second conductive devices;

FIG. 15 is a bottom perspective view of the material handling container of FIG. 14;

FIG. 16 is a top plan view of the material handling container of FIGS. 14 and 15;

FIG. 17 is an enlarged fragmentary top plan view of a portion of the material handling container within Circle D of FIG. 16, showing the first conductive device of the electrical discharge assembly;

FIG. 18 is an elevational view of the material handling container of FIGS. 14-16;

FIG. 19 is an enlarged fragmentary elevational view of a portion of the material handling container within Circle E of FIG. 18, showing a latch for a sidewall panel of the material handling container configured to electrically connect first and second portions of a connector of the electrical discharge assembly;

FIG. 20 is an elevational view of a container stack according to an embodiment of the present disclosure, wherein the container stack includes a plurality of the material handling containers shown in FIGS. 14-16;

FIG. 21 is an enlarged fragmentary elevational view of a portion of the container stack within Circle F of FIG. 20, showing an interaction between an electrical discharge assembly of one of the material handling containers and an electrical discharge assembly of another one of the material handling containers when in the stacked relationship of FIG. 20; and

FIG. 22 is an enlarged fragmentary perspective view of a portion of the container stack of FIG. 20, showing an interaction between an electrical discharge assembly of one of the material handling containers and an electrical discharge assembly of another one of the material handling containers when in the stacked relationship of FIG. 20.

### DETAILED DESCRIPTION

The following description of technology is merely exemplary in nature of the subject matter, manufacture and use of one or more present disclosures, and is not intended to limit the scope, application, or uses of any specific present disclosure claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

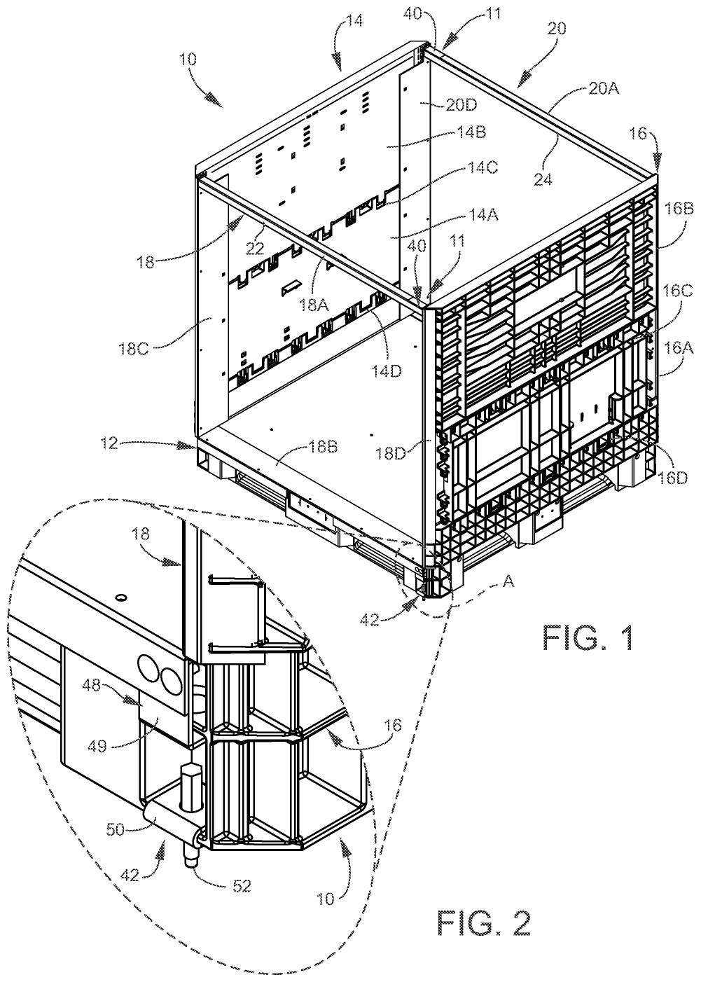

FIG. 1 illustrates a material handling container 10 provided with at least one electrostatic discharge (ESD) assembly 11 according to an embodiment of the present disclosure. The container 10 shown is a non-collapsible container, it is understood, however, that the container 10 may be any container for which electrostatic discharge protection is desired. The container 10 may also be configured to receive dunnage therein. It is also understood that the container 10 shown is in a substantially vertical and erect “in use” position capable of storing and shipping components.

The container 10 depicted includes a base 12 to which are mounted opposed first and second base sidewalls 14, 16 and opposed first and second side frames 18, 20. The base sidewalls 14, 16 may be formed by two sidewall panels 14A, 14B and 16A, 16B, respectively that are joined along an adjoining common hinge line by respective sidewall hinges 14C, 16C. The base sidewalls 14, 16 may be mounted for pivoting movement on the base 12 by base hinges 14D, 16D.

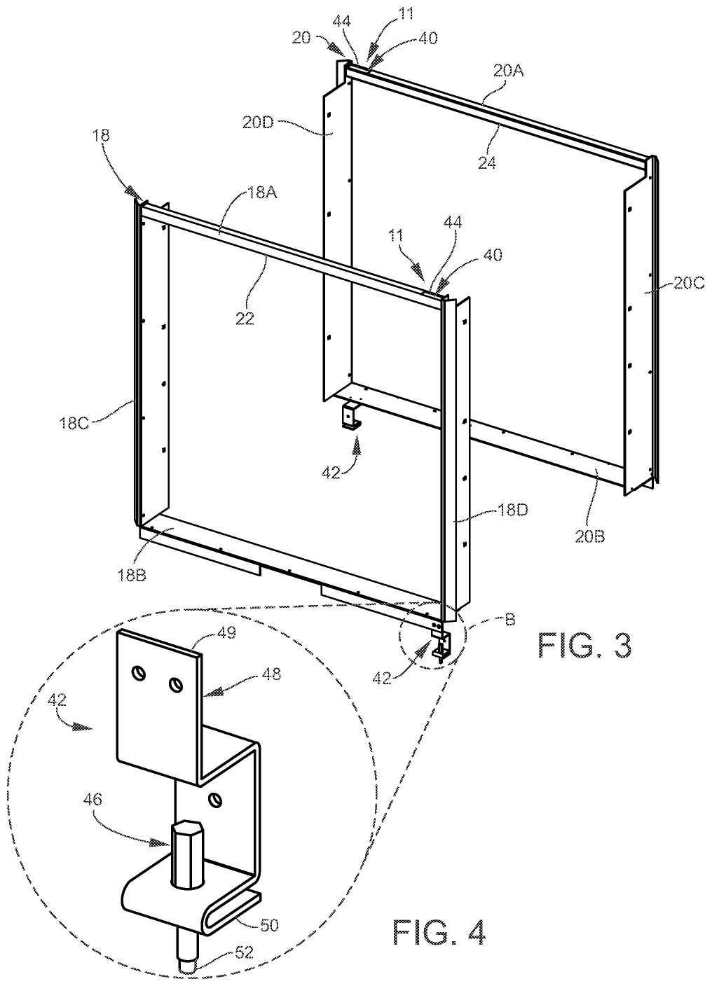

Each of the side frames 18, 20 is disposed between and coupled to the first and second base sidewalls 14, 16. As best shown in FIG. 3, each of the side frames 18, 20 has a generally rectangular shape and includes upper members 18A, 20A, lower members 18B, 20B, first side members 18C, 20C, and opposed second side members 18D, 20D. The side members 18C, 18D of the side frame 18 are disposed between the upper and lower members 18A, 18B. The members 18A, 18B, 18C, 18D may be coupled together to define an opening 22 configured to permit side loading and unloading of components into and from the container 10. Likewise, the side members 20C, 20D of the side frame 20 are disposed between the upper and lower members 20A, 20B. The members 20A, 20B, 20C, 20D may be coupled together to define an opening 24 configured to permit side loading and unloading of components into and from the container 10. In certain embodiments, at least one of the members 18A, 18B, 18C, 18D and/or at least one of the members 20A, 20B, 20C, 20D may be produced from a conductive material such as a steel material, for example. Preferably, the upper and lower members 18A, 18B and at least one of the side members 18C, 18D of the first side frame 18 and/or the upper and lower members 20A, 20B and at least one of the side members 20C, 20D of the second side member 20 may be produced from a conductive material.

Referring back to FIG. 1, the container 10 may include a plurality of ESD assemblies 11 integrated therein. Although the container 10 shown includes two ESD assemblies 11, it is understood that more or less of the ESD assemblies 11 may be employed, if desired. In some embodiments, the ESD assembly 11 may be incorporated into one or more of the side frames 18, 20. It should be appreciated that the ESD assembly 11 may be formed integrally with and/or separately from the one or more side frames 18, 20.

Each of the ESD assemblies 11 shown includes a first conductive device 40 and a second conductive device 42. The first conductive device 40 may be in electrical communication with the second conductive device 42. Preferably, the first conductive device 40 may be electrically connected to the second conductive device 42 via any means for transferring, transmitting, and/or distributing an electrical charge. More or less of the conductive devices 40, 42 than shown may be employed if desired.

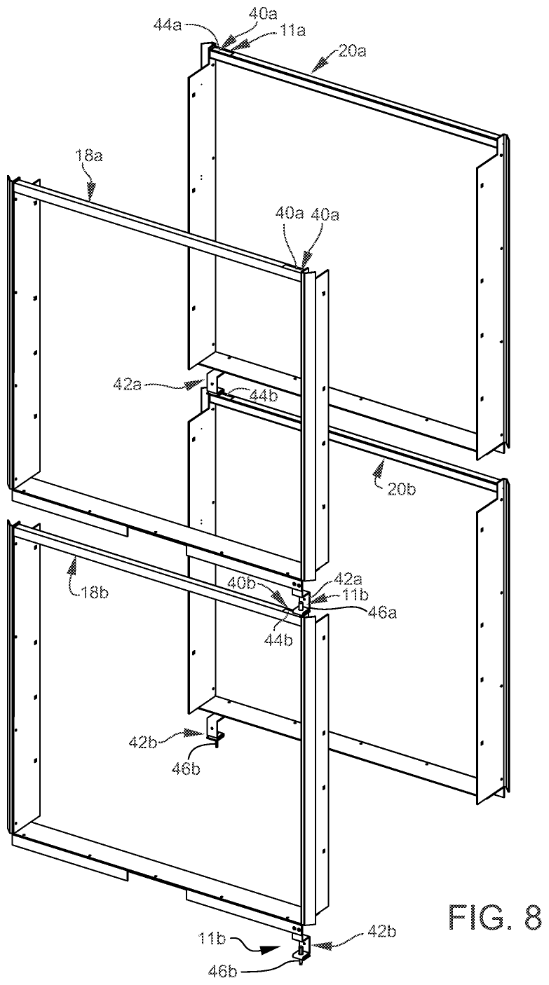

In the embodiment shown in FIGS. 1-9, each of the first conductive devices 40 of the ESD assemblies 11 may be in electrical communication with a corresponding one of the second conductive devices 42 via the associated one of the side frames 18, 20. As best seen in FIG. 3, the first conductive devices 40 may be provided on the upper member 18A of the first side frame 18 and/or the upper member 20A of the second side frame 20. In some embodiments, each of the first conductive devices 40 may include at least one contact member 44. The contact members 44 may be integrally formed with the side frames 18, 20 or formed as separate and distinct components, if desired. The contact members 44 may be substantially planer to provide a desired contact surface. Although each of the contact members 44 has a generally rectangular shape, it should be appreciated that the contact members 44 may have any suitable shape and size as desired. More or less of the contact members 44 than shown may be employed if desired.

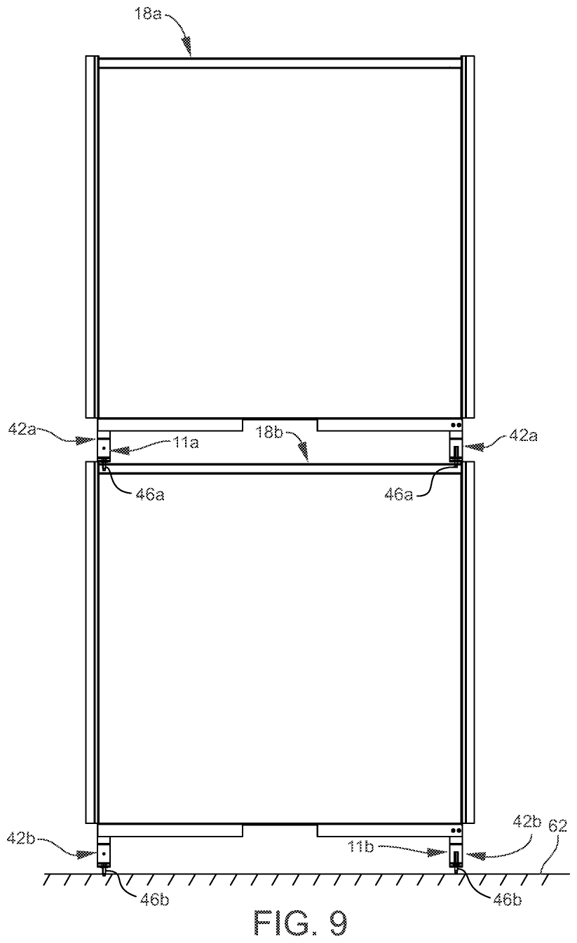

In preferred embodiments, at least a portion of the first conductive devices 40 may be formed from a conductive material and/or a dissipative material. For example, at least a portion of the first conductive devices 40 may be formed from a conductive material and/or dissipative material that is capable of transferring, transmitting, and distributing electrical charge away from the components located in the container 10 and to a grounding structure or a ground 62, shown in FIG. 9. The conductive material and/or the dissipative material may be any suitable material as desired. For example, the conductive material and/or the dissipative material employed for the first conductive devices 40 may have a surface resistivity equal to or less than 1×1012 Ω/square, and preferably in a range from about 1×103 Ω/square to about 1×109 Ω/square or a volume resistivity equal to or less than 1×1012 Ω-meters.

FIG. 3 illustrates an exemplary embodiment of the second conductive device 42. The second conductive devices 42 may be provided on the lower member 18B of the first side frame 18 and/or the lower member 20B of the second side frame 20. For example, each of the second conductive devices 42 may be coupled to an associated one of the lower members 18B, 20B by any mechanical means (e.g. mechanical fasteners). It is understood, however, that any method to couple the second conductive devices 42 to the lower members 18B, 20B may be employed.

As best seen in FIG. 4, each of the second conductive devices 42 may include at least one contact member 46. An attachment mechanism 48 (e.g. a bracket) may be used to couple the second conductive devices 42 to the side frames 18, 20 and permit a transferring, transmitting, and distributing of electrical charge from the side frames 18, 20 to the second conductive devices 42. It is understood, however, that the second conductive devices 42 may be integrally formed with side frames 18, 20, preferably the lower members 18B, 20B, if desired. In some embodiments, the attachment mechanism 48 may comprise a first portion 49 and a second portion 50. The first portion 49 may have a generally “S” shaped cross-section and the second portion 50 may have a generally “C” shaped cross-section. As more clearly shown in FIG. 2, the first portion 49 may be configured for coupling the second conductive device 42 to the side frames 18, 20, preferably the lower members 18B, 20B, and the second portion 50 may be configured to retain the at least contact member 46 therein and engage the base 12 of the container 10. It is understood that the attachment mechanism 48 may have any shape, size, and configuration or other suitable structure as desired.

In certain embodiments, the at least one contact member 46 of the second conductive devices 42 may include a movable element 52 (e.g., a spring-loaded plunger) configured to provide a desired contact surface. More or less of the contact members 46 than shown may be employed in each of the second conductive devices 42, if desired. In some embodiments, the movable element 52 may be rigid, compact, and designed to fit within confines of the container 10. As illustrated, the movable element 52 is retractable and may only minimally extend past the container 10 to allow for grounding yet movable to a position at least partially surrounded by at least a portion of the container 10 for protection and to minimize a risk of damage thereto and/or detachment thereof. As such, a durability and longevity of the ESD assembly 11 may be enhanced.

In certain embodiments, at least a portion of the second conductive devices 42 may be formed from a conductive material and/or a dissipative material. For example, at least a portion of the second conductive devices 42 may be formed from a conductive material and/or dissipative material that is capable of transferring, transmitting, and distributing electrical charge away from the components located in the container 10 and to the ground 62, shown in FIG. 9. The conductive material and/or the dissipative material may be any suitable material as desired. For example, the conductive material and/or the dissipative material employed for the second conductive devices 42 may have a surface resistivity equal to or less than 1×1012 Ω/square, and preferably in a range from about 1×103 Ω/square to about 1×109 Ω/square or a volume resistivity equal to or less than 1×1012 Ω-meters.

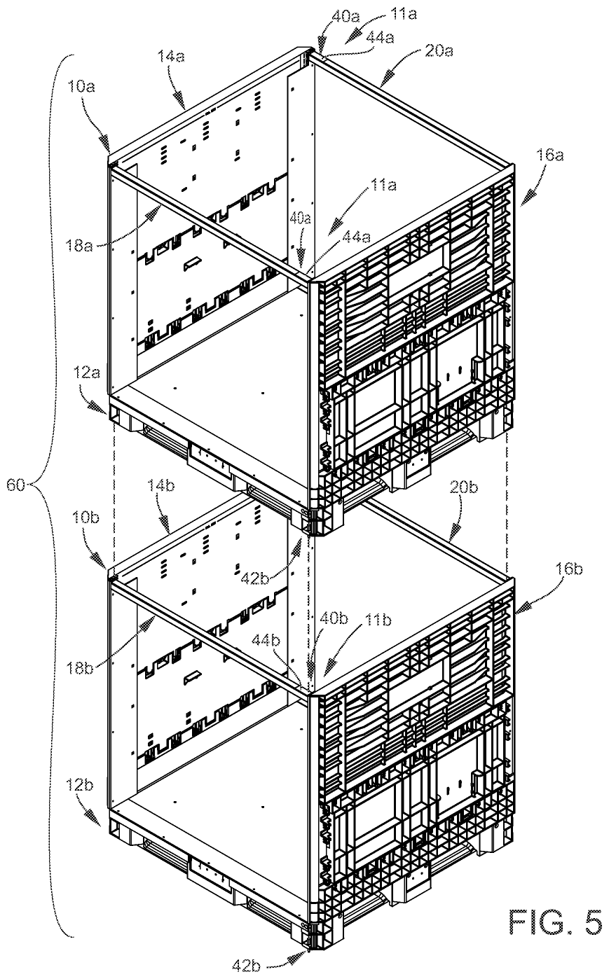

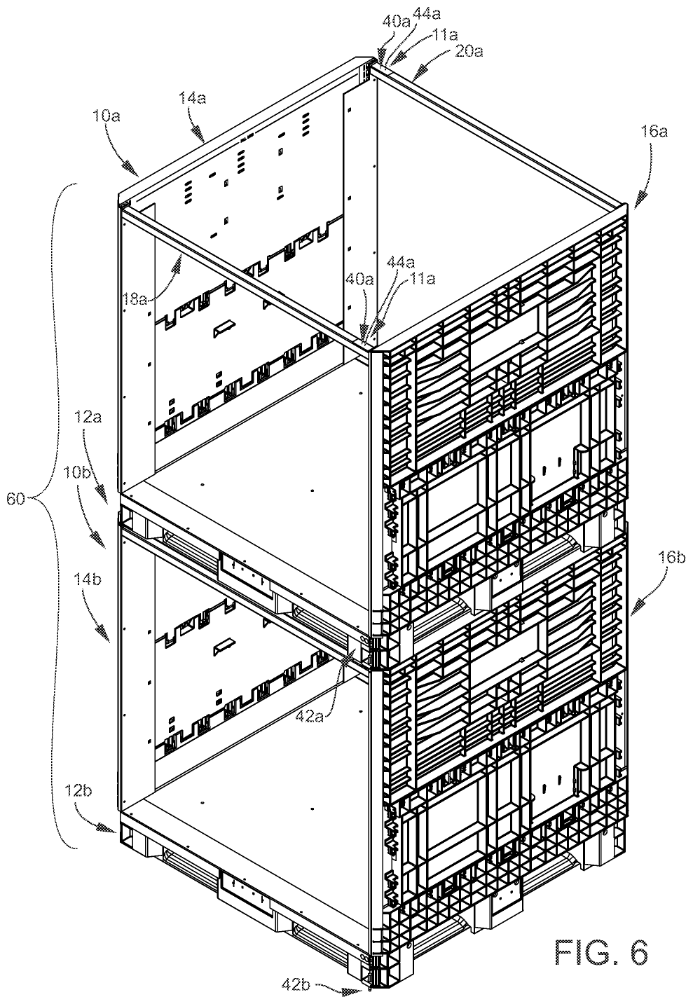

FIGS. 5-6 depict a pair of the containers 10 in a stacked relationship 60. When in the stacked relationship 60, at least one of the ESD assemblies 11 of a first container 10a is in electrical communication with at least one of the ESD assemblies 11 of a second container 10b, which is further in electrical communication with the ground 62. Preferably, when in the stacked relationship, the first conductive devices 40 of the ESD assemblies 11 of the first container 10a are in electrical communication via the side frames 18, 20 with the second conductive devices 42 of the ESD assemblies 11 of the first container 10a, and the second conductive devices 42 of the ESD assemblies 11 of the first container 10a are in electrical communication with the first conductive devices 40 of the ESD assemblies 11 of the second container 10b. The first conductive devices 40 of the ESD assemblies 11 of the second container 10b are in electrical communication via the side frames 18, 20 with the second conductive devices 42 of the ESD assemblies 11 of the second container 10b, which are then in electrical communication with the ground 62.

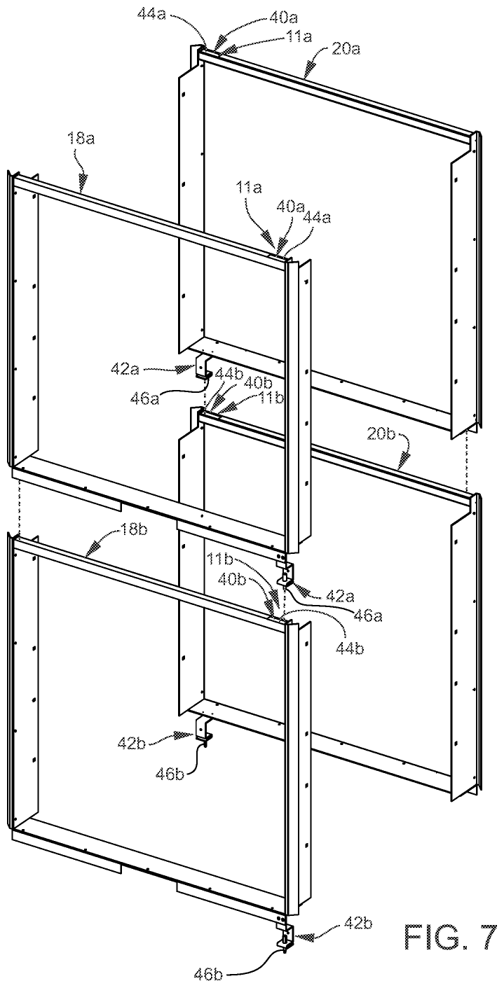

As best seen in FIGS. 7-9, the contact members 46 of the second conductive devices 42 are located on the container 10 and configured in such a manner that when the containers 10a, 10b are in the stacked relationship 60 at least one of the contact members 46 of the second conductive devices 42 of the first container 10a is in direct contact with at least one of the contact members 44 of the first conductive devices 40 of the second container 10b and at least one of the contact members 46 of the second conductive devices 42 of the second container 10b is in direct contact with the ground 62.

Accordingly, the electrical charge may be transferred, transmitted, and/or distributed from components and/or dunnage within one or more containers 10, through one or more of the ESD assemblies 11 and the side frames 18, 20, to the ground 62 without any intervention or additional obligations of an operator to connect the one or more containers 10.

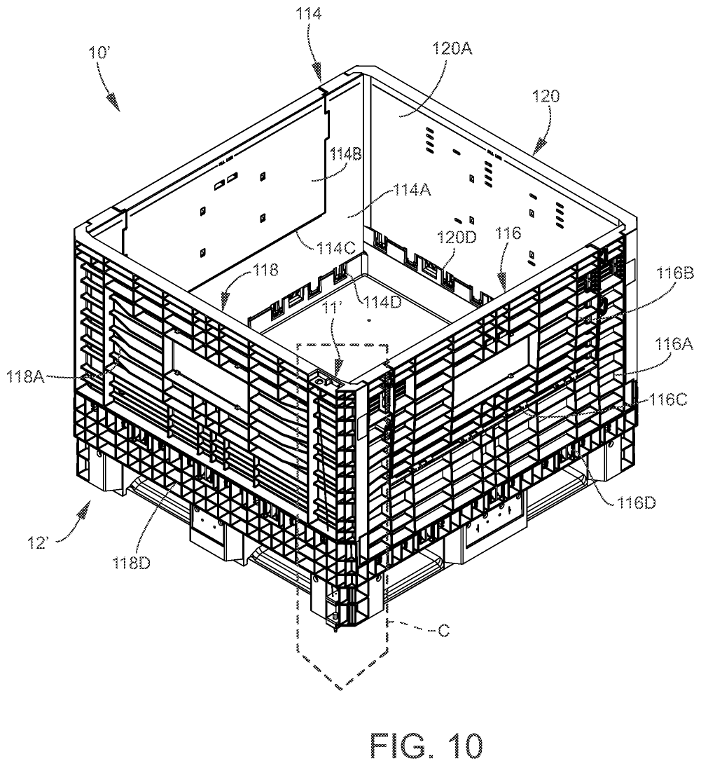

FIG. 10 illustrates a material handling container 10′ provided with at least one electrostatic discharge (ESD) assembly 11′ according to another embodiment of the present disclosure. Similar structure to that described above for FIGS. 1-9, which is repeated herein with respect to FIGS. 10-13, includes the same reference numeral and a prime (′) symbol. The container 10′ shown is a collapsible container, it is understood, however, that the container 10′ may be any container for which electrostatic discharge protection is desired. Additionally, the container 10′ may be configured to receive dunnage therein. It is also understood that the container 10′ shown is in a substantially vertical and erect “in use” position capable of storing and shipping components, and may be collapsible into a substantially horizontal and flat “stowed” position.

The container 10′ depicted includes a base 12′ to which are mounted opposed first and second base sidewalls 114, 116 and opposed third and fourth base sidewalls 118, 120. The base sidewalls 114, 116 may be formed by two sidewall panels 114A, 114B and 116A, 116B, respectively that are joined along an adjoining common hinge line by respective sidewall hinges 114C, 116C and the base sidewall 118, 120 may be formed by a single sidewall panel 118A, 120A, respectively. The base sidewalls 114, 116, 118, 120 may be mounted for pivoting movement on the base 12′ by base hinges 114D, 116D, 118D, 120D.

The container 10′ may include at least one ESD assembly 11′ integrated therein. Although the container 10′ shown includes a single ESD assembly 11′, it is understood that more or less of the ESD assemblies 11′ may be employed, if desired. In some embodiments, the ESD assembly 11′ may be incorporated into one or more of the base 12′ and the base sidewalls 114, 116, 118, 120. It should be appreciated that the ESD assembly 11′ may be formed integrally with and/or separately from the one or more of the base 12′ and the base sidewalls 114, 116, 118, 120.

The ESD assembly 11′ shown includes a first conductive device 40′ and a second conductive device 42′. The first conductive device 40′ may be in electrical communication with the second conductive device 42′. Preferably, the first conductive device 40′ may be connected to the second conductive device 42′ via any means for transferring, transmitting, and/or distributing an electrical charge. More or less of the conductive devices 40′, 42′ than shown may be employed if desired.

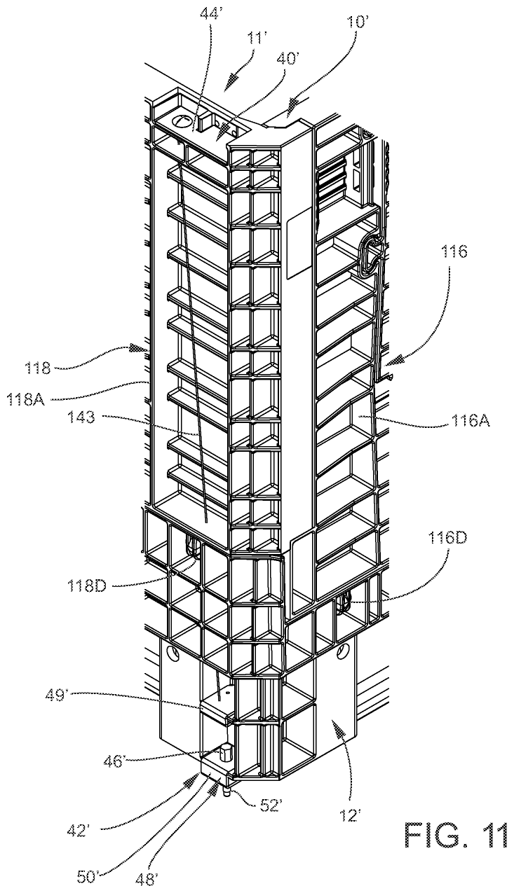

In the embodiment shown in FIGS. 10-13, the first conductive device 40′ of the ESD assembly 11′ may be in electrical communication with the second conductive device 42′ via a connector 143. Although the connector 143 shown is single, flexible wire, it is understood that the connector 143 may have any shape, size, and configuration or be comprised of various other structures, as desired. It is also understood that the connector 143 may be a rigid rod if desired. As best seen in FIG. 11, the first conductive device 40′ may be provided on an upper portion of the third base sidewall 118. It should be appreciated that the first conductive device 40′ may be provided on any of the base 12′ and the base sidewalls 114, 116, 120 and/or at any location, if desired. In some embodiments, the first conductive device 40′ may include at least one contact member 44′. The contact member 44′ may be integrally formed with the third base sidewall 118 or formed as separate and distinct component, if desired. The contact member 44′ may be substantially planer to provide a desired contact surface. Although the contact member 44′ has a generally rectangular shape, it should be appreciated that the contact member 44′ may have any suitable shape and size as desired. More or less of the contact members 44′ than shown may be employed if desired.

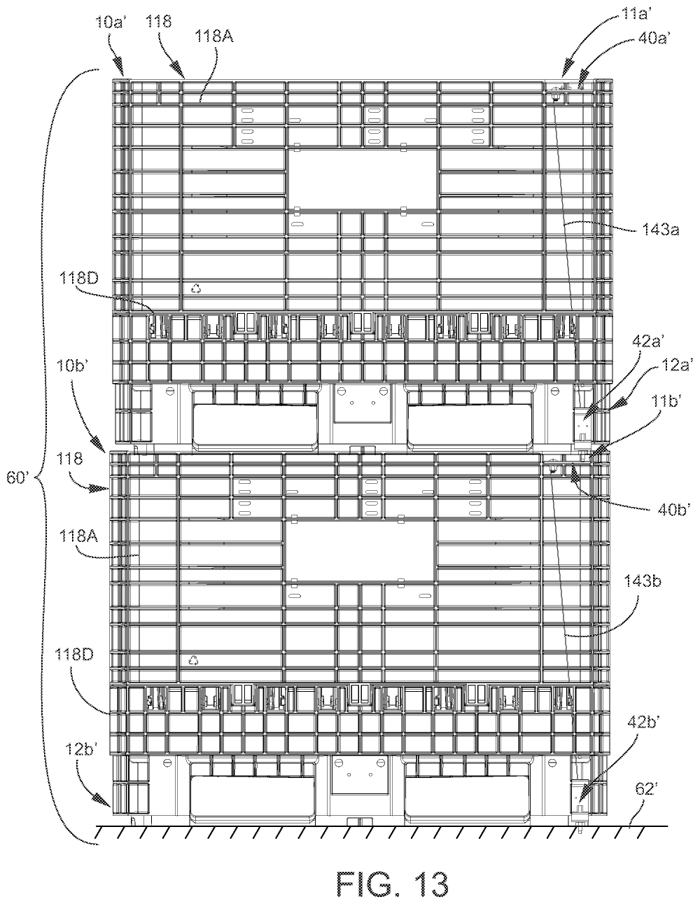

In preferred embodiments, at least a portion of the first conductive device 40′ may be formed from a conductive material and/or a dissipative material. For example, at least a portion of the first conductive device 40′ may be formed from a conductive material and/or dissipative material that is capable of transferring, transmitting, and distributing electrical charge away from the components located in the container 10′ and to a grounding structure or a ground 62′, shown in FIG. 13. The conductive material and/or the dissipative material may be any suitable material as desired. For example, the conductive material and/or the dissipative material employed for the first conductive devices 40 may have a surface resistivity equal to or less than 1×1012 Ω/square, and preferably in a range from about 1×103 Ω/square to about 1×109 Ω/square or a volume resistivity equal to or less than 1×1012 Ω-meters.

The second conductive device 42′ may be provided on a lower portion of the base 12′. For example, the second conductive device 42′ may be coupled to the base 12′ by any mechanical means (e.g. mechanical fasteners). It is understood, however, that any method to couple the second conductive device 42′ to the base 12′ may be employed. It should be appreciated that the second conductive device 42′ may be provided on any of the base 12′ and the base sidewalls 114, 116, 118, 120 and/or at any location, if desired.

Referring back to FIG. 11, the second conductive device 42′ may include at least one contact member 46′. An attachment mechanism 48′ (e.g. a bracket) may be used to couple the second conductive device 42′ to the connector 143 and permit a transferring, transmitting, and distributing of electrical charge from the connector 143 to the second conductive device 42′. It is understood, however, that the second conductive device 42′ may be integrally formed with the third base sidewall 118, preferably the lower portion thereof, if desired. In some embodiments, the attachment mechanism 48′ may comprise a first portion 49′ and a second portion 50′. The first portion 49′ may have a generally “S” shaped cross-section and the second portion 50′ may have a generally “C” shaped cross-section. The first portion 49′ may be configured for coupling the second conductive device 42′ to the third base sidewall 118 and the second portion 50′ may be configured to retain the at least contact member 46′ therein and engage the base 12′ of the container 10′. It is understood that the attachment mechanism 48′ may have any shape, size, and configuration or other suitable structure as desired.

In certain embodiments, the at least one contact member 46′ of the second conductive device 42′ may include a movable element 52′ (e.g., a spring-loaded plunger) configured to provide a desired contact surface. More or less of the contact members 46′ than shown may be employed in each of the second conductive devices 42′, if desired. In some embodiments, the movable element 52′ may be rigid, compact, and designed to fit within confines of the container 10′. As illustrated, the movable element 52′ is retractable and may only minimally extend past the container 10′ to allow for grounding yet movable to a position at least partially surrounded by at least a portion of the container 10′ for protection and to minimize a risk of damage thereto and/or detachment thereof. As such, a durability and longevity of the ESD assembly 11′ may be enhanced.

In certain embodiments, at least a portion of the second conductive device 42′ may be formed from a conductive material and/or a dissipative material. For example, at least a portion of the second conductive device 42′ may be formed from a conductive material and/or dissipative material that is capable of transferring, transmitting, and distributing electrical charge away from the components located in the container 10′ and to the ground 62′, shown in FIG. 13. The conductive material and/or the dissipative material may be any suitable material as desired. For example, the conductive material and/or the dissipative material employed for the second conductive devices 42′ may have a surface resistivity equal to or less than 1×1012 Ω/square, and preferably in a range from about 1×103 Ω/square to about 1×109 Ω/square or a volume resistivity equal to or less than 1×1012 Ω-meters.

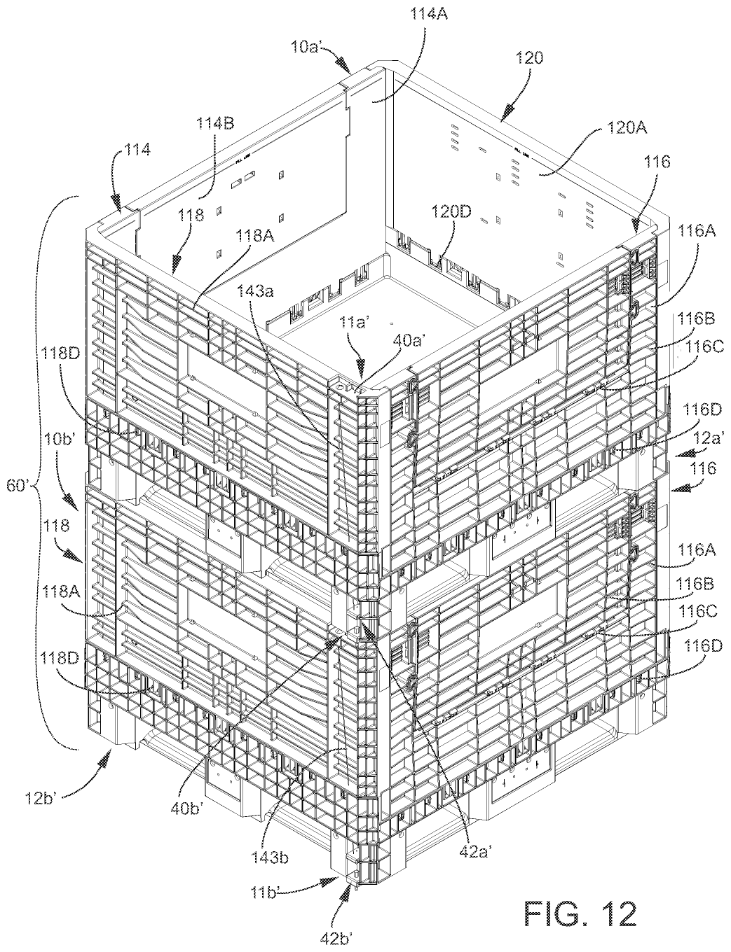

FIGS. 12-13 depict a pair of the containers 10′ in a stacked relationship 60′. When in the stacked relationship 60′, the ESD assembly 11a′ of a first container 10a′ is in electrical communication with the ESD assembly 11b′ of a second container 10b′, which is further in electrical communication with the ground 62′. Preferably, when in the stacked relationship, the first conductive device 40a′ of the ESD assembly 11a′ of the first container 10a′ is in electrical communication via the connector 143a with the second conductive device 42a′ of the ESD assembly 11a′ of the first container 10a′, and the second conductive device 42a′ of the ESD assembly 11a′ of the first container 10a′ is in electrical communication with the first conductive device 40b′ of the ESD assembly 11b′ of the second container 10b′. The first conductive device 40b′ of the ESD assembly 11b′ of the second container 10b′ is in electrical communication via the connector 143b with the second conductive device 42b′ of the ESD assembly 11b′ of the second container 10b′, which are then in electrical communication with the ground 62′.

The contact member 46a′ of the second conductive device 42a′ of the first container 10a′ is located on the first container 10a′ and configured in such a manner that when the containers 10a′, 10b′ are in the stacked relationship 60′ the contact member 46a′ of the second conductive device 42a′ of the first container 10a′ is in direct contact with the contact member 44b′ of the first conductive device 40b′ of the second container 10b′ and the contact member 46b′ of the second conductive device 42b′ of the second container 10b′ is in direct contact with the ground 62′.

Accordingly, the electrical charge may be transferred, transmitted, and/or distributed from components and/or dunnage within one or more containers 10′, through one or more of the ESD assemblies 11′ and one or more of the connectors 143, to the ground 62′ without any intervention or additional obligations of an operator to connect the one or more containers 10′.

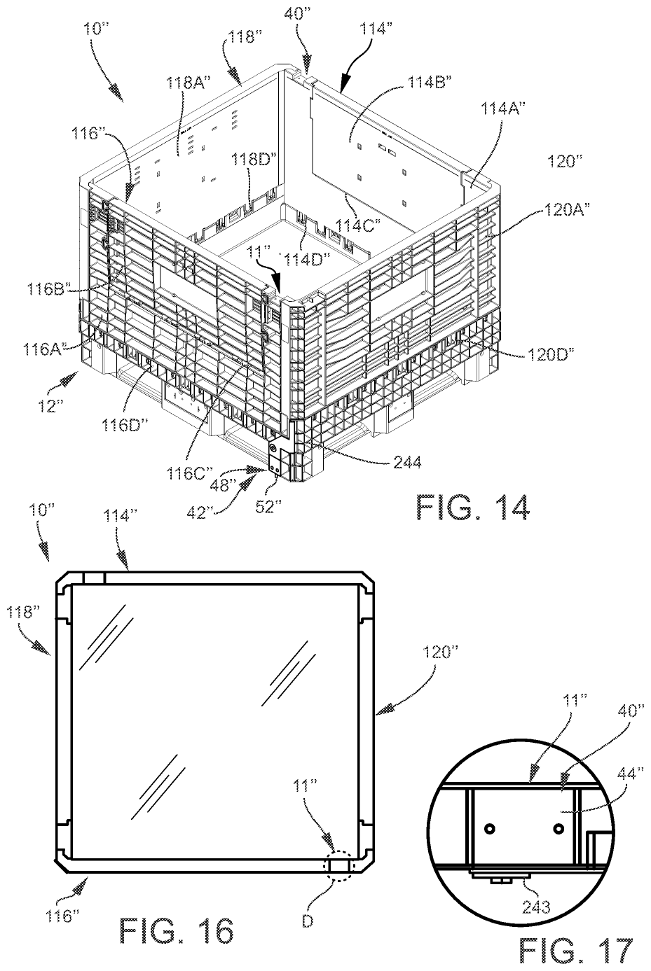

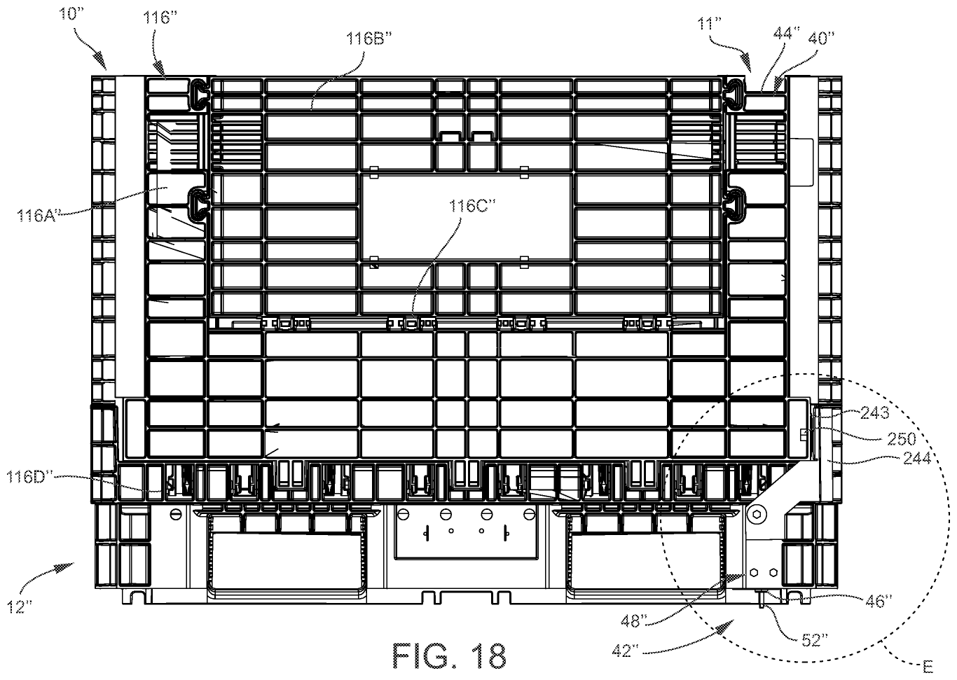

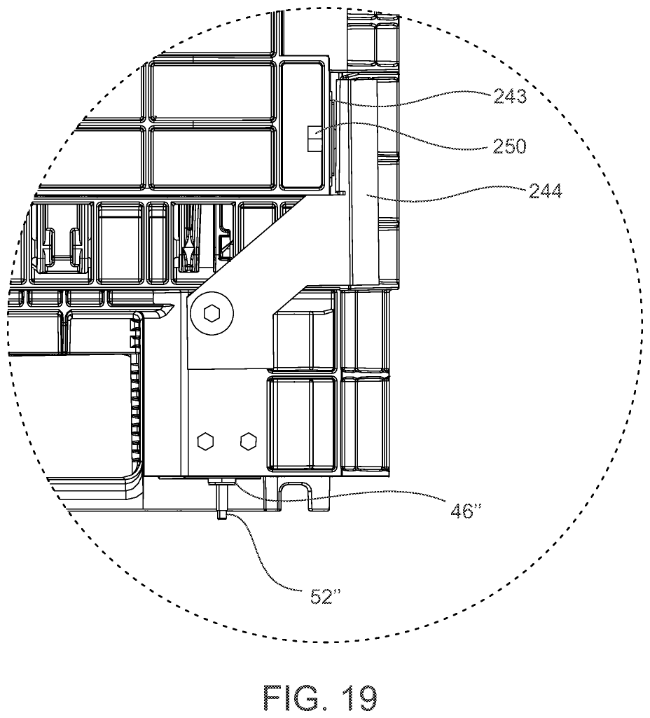

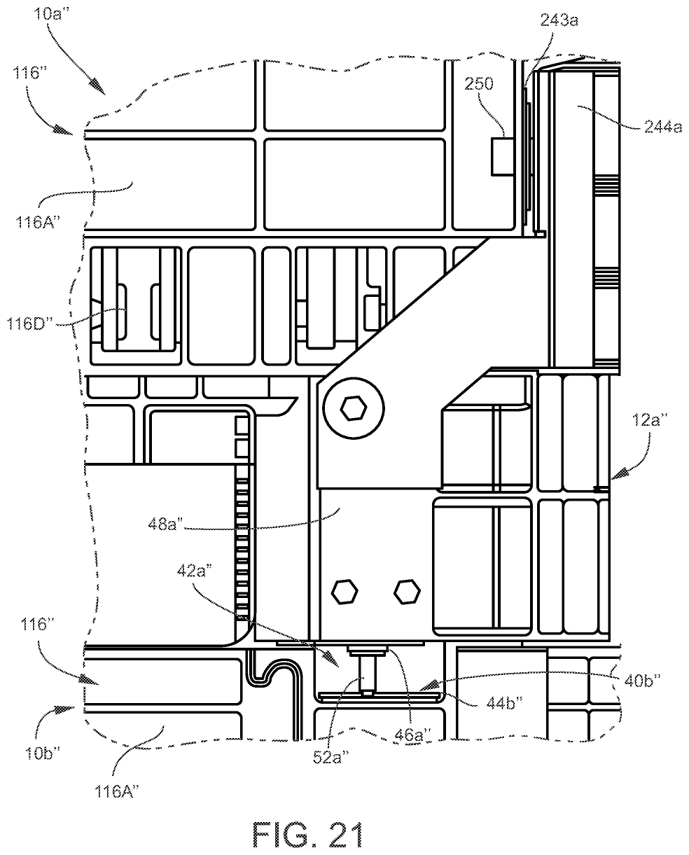

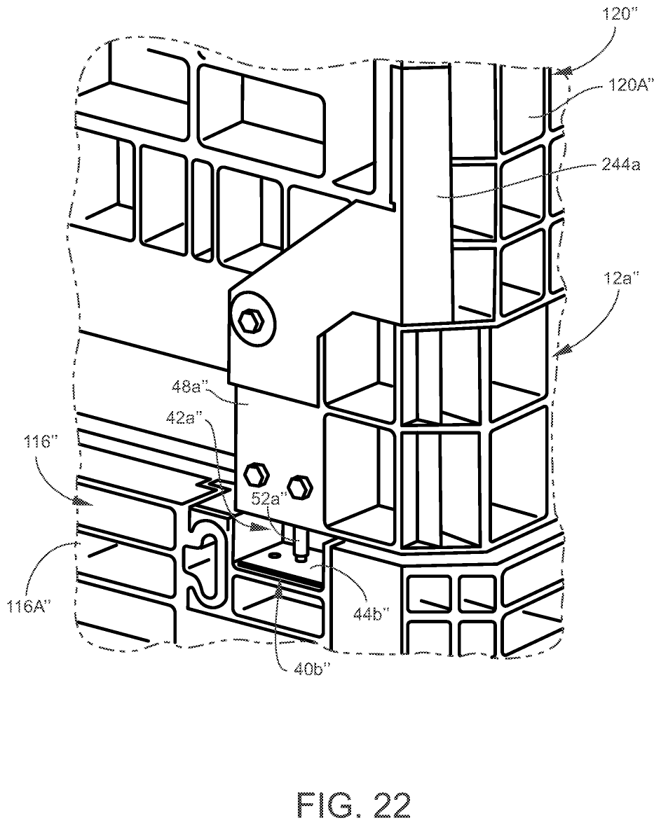

FIGS. 14-22 illustrates a material handling container 10″ provided with at least one electrostatic discharge (ESD) assembly 11″ according to another embodiment of the present disclosure. Similar structure to that described above for FIGS. 1-13, which is repeated herein with respect to FIGS. 14-22, includes the same reference numeral and a double prime (″) symbol. The container 10″ shown is a collapsible container, it is understood, however, that the container 10″ may be any container for which electrostatic discharge protection is desired. Additionally, the container 10″ may be configured to receive dunnage therein. It is also understood that the container 10″ shown is in a substantially vertical and erect “in use” position capable of storing and shipping components, and may be collapsible into a substantially horizontal and flat “stowed” position.

The container 10″ depicted includes a base 12″ to which are mounted opposed first and second base sidewalls 114″, 116″ and opposed third and fourth base sidewalls 118″, 120″. The base sidewalls 114″, 116″ may be formed by two sidewall panels 114A″, 114B″ and 116A″, 116B″, respectively that are joined along an adjoining common hinge line by respective sidewall hinges 114C″, 116C″ and the base sidewall 118″, 120″ may be formed by a single sidewall panel 118A″, 120A″, respectively. The base sidewalls 114″, 116″, 118″, 120″ may be mounted for pivoting movement on the base 12″ by base hinges 114D″, 116D″, 118D″, 120D″.

The container 10″ may include at least one ESD assembly 11″ integrated therein. Although the container 10″ shown includes a single ESD assembly 11″, it is understood that more or less of the ESD assemblies 11″ may be employed, if desired. In some embodiments, the ESD assembly 11″ may be incorporated into one or more of the base 12″ and the base sidewalls 114″, 116″, 118″, 120″. It should be appreciated that the ESD assembly 11″ may be formed integrally with and/or separately from the one or more of the base 12″ and the base sidewalls 114″, 116″, 118″, 120″.

The ESD assembly 11″ shown includes a first conductive device 40″ and a second conductive device 42″. The first conductive device 40″ may be in electrical communication with the second conductive device 42″. Preferably, the first conductive device 40″ may be connected to the second conductive device 42″ via any means for transferring, transmitting, and/or distributing an electrical charge. More or less of the conductive devices 40″, 42″ than shown may be employed if desired.

In the embodiment shown in FIGS. 14-22, the first conductive device 40″ of the ESD assembly 11″ may be in electrical communication with the second conductive device 42″ via a multi-piece connector. It is understood that any suitable connector may be employed as desired. The connector may have any shape, size, and configuration or be comprised of various structures, as desired. The connector depicted comprises a first piece 243 and a second piece 244. An electrical jumper 250 (e.g., a latch, a ball latch, etc.) releasably couples at least one of the sidewall panels 114B″, 116B″ to the respective one of the sidewall panels 114A″, 116A″ and electrically connects the first piece 243 of the connector to the second piece 244. As illustrated, the first piece 243 of the connector is electrically coupled to the first conductive device 40″ and extends along an inside of the container 10″ to the jumper 250. Similarly, the second piece 244 is electrically coupled to the second conductive device 42″ and extends along an outside of the container 10″ to the jumper 250. It is understood that each of the pieces 243, 244 may have any shape, size, and configuration to electrically connect the first conductive device 40″ to the second conductive device 42″. The jumper 250 electrically connects the first piece 243 of the connector to the second piece 244 of the connector when at least one of the sidewall panels 114″, 116″ is in a closed first position (container erect) capable of storing and shipping components. In contrast, the jumper 250 electrically disconnects the first piece 243 from the second piece 244 when at least one of the sidewall panels 114″, 116″ is in an open second position (container collapsed) capable of allowing container to be collapsed without interference. The jumper 250 may be any suitable connector that may be used to open and close an electrical circuit.

As best seen in FIG. 14, the first conductive device 40″ may be provided on an upper portion of the second base sidewall 116″. It should be appreciated that the first conductive device 40″ may be provided on any of the base 12″ and the base sidewalls 114″, 118″, 120″ and/or at any location, if desired. In some embodiments, the first conductive device 40″ may include at least one contact member 44″. The contact member 44″ may be integrally formed with the second base sidewall 116″ or formed as separate and distinct component, if desired. The contact member 44″ may be substantially planer to provide a desired contact surface. Although the contact member 44″ has a generally rectangular shape, it should be appreciated that the contact member 44″ may have any suitable shape and size as desired. More or less of the contact members 44″ than shown may be employed if desired.

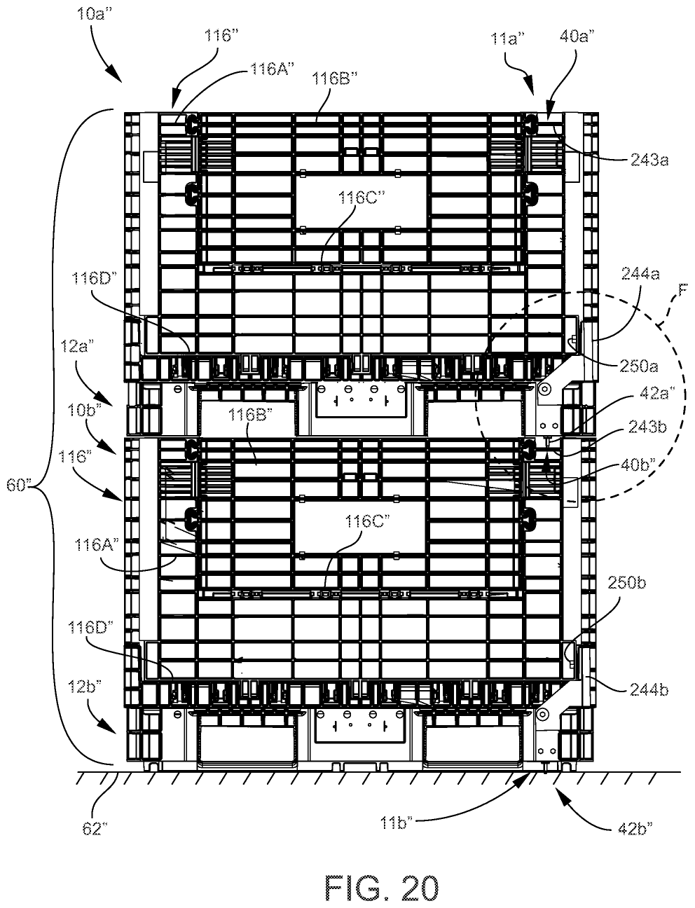

In preferred embodiments, at least a portion of the first conductive device 40″ may be formed from a conductive material and/or a dissipative material. For example, at least a portion of the first conductive device 40″ may be formed from a conductive material and/or dissipative material that is capable of transferring, transmitting, and distributing electrical charge away from the components located in the container 10″ and to a grounding structure or a ground 62″, shown in FIG. 20. The conductive material and/or the dissipative material may be any suitable material as desired. For example, the conductive material and/or the dissipative material employed for the first conductive devices 40 may have a surface resistivity equal to or less than 1×1012 Ω/square, and preferably in a range from about 1×103 Ω/square to about 1×109 Ω/square or a volume resistivity equal to or less than 1×1012 Ω-meters.

The second conductive device 42″ may be provided on a lower portion of the base 12″. For example, the second conductive device 42″ may be coupled to the base 12″ by any mechanical means (e.g. mechanical fasteners). It is understood, however, that any method to couple the second conductive device 42″ to the base 12″ may be employed. It should be appreciated that the second conductive device 42″ may be provided on any of the base 12″ and the base sidewalls 114″, 116″, 118″, 120″ and/or at any location, if desired.

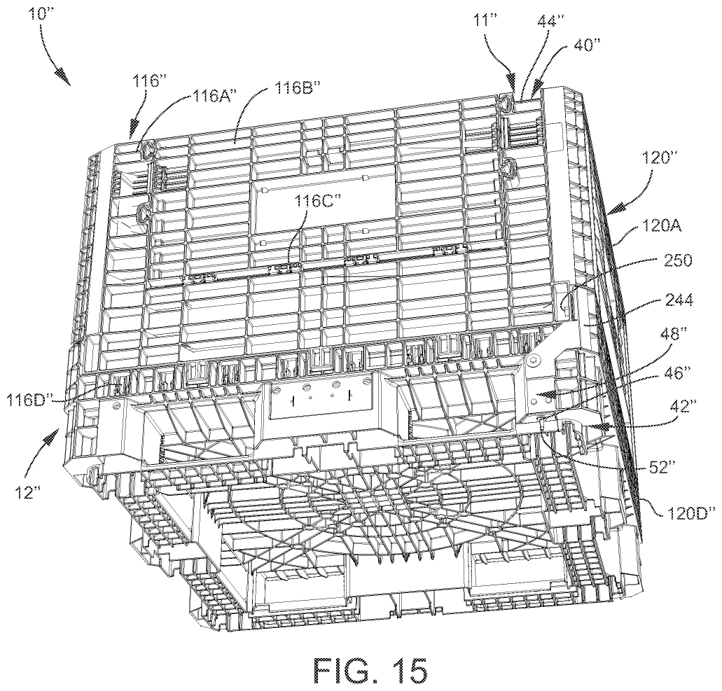

As more clearly depicted in FIG. 15, the second conductive device 42″ may include at least one contact member 46″. An attachment mechanism 48″ (e.g. a bracket) may be used to couple the second conductive device 42″ to the second piece 244 of the connector and permit a transferring, transmitting, and distributing of electrical charge from the second piece 244 of the connector to the second conductive device 42″. It is understood, however, that the second conductive device 42 “may be directly coupled to the second piece 244 of the connector, without the attachment mechanism 48”, to permit the transferring, transmitting, and distributing of electrical charge from the second piece 244 of the connector to the second conductive device 42″. It is further understood that the second conductive device 42″ may be integrally formed with the second base sidewall 116″, preferably the lower portion thereof, if desired.

In some embodiments, the attachment mechanism 48″ may at least one shaped conductive and/or dissipative member configured to couple the second conductive device 42″ to the base 12″ and/or retain the at least contact member 46″ therein and engage the base 12″ of the container 10″. It is understood that the attachment mechanism 48″ may have any shape, size, and configuration or other suitable structure as desired.

In certain embodiments, the at least one contact member 46″ of the second conductive device 42″ may include a movable element 52″ (e.g., a spring-loaded plunger) configured to provide a desired contact surface. More or less of the contact members 46″ than shown may be employed in each of the second conductive devices 42″, if desired. In some embodiments, the movable element 52″ may be rigid, compact, and designed to fit within confines of the container 10″. As illustrated, the movable element 52″ is retractable and may only minimally extend past the container 10″ to allow for grounding yet movable to a position at least partially surrounded by at least a portion of the container 10″ for protection and to minimize a risk of damage thereto and/or detachment thereof. As such, a durability and longevity of the ESD assembly 11″ may be enhanced.

In certain embodiments, at least a portion of the second conductive device 42″ may be formed from a conductive material and/or a dissipative material. For example, at least a portion of the second conductive device 42″ may be formed from a conductive material and/or dissipative material that is capable of transferring, transmitting, and distributing electrical charge away from the components located in the container 10″ and to the ground 62″, shown in FIG. 20. The conductive material and/or the dissipative material may be any suitable material as desired. For example, the conductive material and/or the dissipative material employed for the second conductive devices 42″ may have a surface resistivity equal to or less than 1×1012 Ω/square, and preferably in a range from about 1×103 Ω/square to about 1×109 Ω/square or a volume resistivity equal to or less than 1×1012 Ω-meters.

FIGS. 20-22 depict a pair of the containers 10″ in a stacked relationship 60″. When in the stacked relationship 60″, the ESD assembly 11a″ of a first container 10a″ is in electrical communication with the ESD assembly 11b″ of a second container 10b″, which is further in electrical communication with the ground 62″. Preferably, when in the stacked relationship, the first conductive device 40a″ of the ESD assembly 11a″ of the first container 10a″ is in electrical communication, via the pieces 243a, 244a of the connector and the jumper 250a, with the second conductive device 42a″ of the ESD assembly 11a″ of the first container 10a″, and the second conductive device 42a″ of the ESD assembly 11a″ of the first container 10a″ is in electrical communication with the first conductive device 40b″ of the ESD assembly 11b″ of the second container 10b″. The first conductive device 40b″ of the ESD assembly 11b″ of the second container 10b″ is in electrical communication via the pieces 243b, 244b of the connector and the jumper 250b with the second conductive device 42b″ of the ESD assembly 11b″ of the second container 10b″, which are then in electrical communication with the ground 62″.

The contact member 46a″ of the second conductive device 42a″ of the first container 10a″ is located on the first container 10a″ and configured in such a manner that when the containers 10a″, 10b″ are in the stacked relationship 60″ the contact member 46a″ of the second conductive device 42a″ of the first container 10a″ is in direct contact with the contact member 44b″ of the first conductive device 40b″ of the second container 10b″ and the contact member 46b″ of the second conductive device 42b″ of the second container 10b″ is in direct contact with the ground 62″.

Accordingly, the electrical charge may be transferred, transmitted, and/or distributed from components and/or dunnage within one or more containers 10″, through one or more of the ESD assemblies 11″ and one or more of the connectors via the pieces 243, 244 of the connector and the jumper 250, to the ground 62″ without any intervention or additional obligations of an operator to connect the one or more containers 10″.

A container according to the present disclosure has been described with reference to specific embodiments and examples. Various details of the present disclosure may be changed without departing from the scope of the present disclosure. Furthermore, the foregoing description of the preferred embodiments of the present disclosure and best mode for practicing the present disclosure are provided for the purpose of illustration only and not for the purpose of limitation, the present disclosure being defined by the claims.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. An electrostatic discharge assembly for a container, comprising:
at least one conductive device configured to be coupled to a container for electrical communication with a ground, wherein the at least one conductive device includes a rigid movable element configured to be in selective electrical communication with the ground.

2. The electrostatic discharge assembly of claim 1, wherein the movable element is retractable to a position at least partially surrounded by at least a portion of the container.

3. The electrostatic discharge assembly of claim 1, wherein the movable element is a spring-loaded plunger.

4. The electrostatic discharge assembly of claim 1, wherein the movable element is configured for electrical communication with at least one conductive device of another container.

5. An electrostatic discharge assembly for a container, comprising:
a first conductive device configured to be coupled to a container; and
a second conductive device electrically connected to the first conductive device, and wherein the second conductive device is in selective electrical communication with a ground.

6. The electrostatic discharge assembly of claim 5, wherein the first conductive device is electrically connected to the second conductive device by a frame of the container.

7. The electrostatic discharge assembly of claim 5, further comprising a connector to electrically connect the first conductive device to the second conductive device.

8. The electrostatic discharge assembly of claim 7, wherein the connector includes a first piece, a second piece, and an electrical jumper to selectively electrically connect the first piece and the second piece.

9. The electrostatic discharge assembly of claim 5, wherein the second conducive device includes a movable element configured to be in selective electrical communication with the ground.

10. The electrostatic discharge assembly of claim 9, wherein the movable element is rigid.

11. The electrostatic discharge assembly of claim 9, wherein the movable element is retractable to a position at least partially surrounded by at least a portion of the container.

12. The electrostatic discharge assembly of claim 9, wherein the movable element is configured for electrical communication with a first conductive device of another container.

13. A material handling container, comprising:
a base;
at least one sidewall coupled to the base; and
an electrostatic discharge assembly integrated into at least one of the base and the at least one sidewall, the electrostatic discharge assembly comprising:
a first conductive device; and
a second conductive device electrically connected to the first conductive device, wherein the second conductive device is in selective electrical communication with a ground.

14. The material handling container of claim 13, wherein the first conductive device is coupled to an upper portion of the at least one sidewall of the container.

15. The material handling container of claim 13, wherein the second conductive device is coupled to a lower portion of the base of the container.

16. The material handling container of claim 13, wherein the first conductive device is electrically connected to the second conductive device by a frame of the container.

17. The material handling container of claim 13, further comprising a connector to electrically connect the first conductive device to the second conductive device.

18. The material handling container of claim 17, wherein the connector includes a first piece, a second piece, and an electrical jumper to selectively electrically connect the first piece and the second piece.

19. The material handling container of claim 13, wherein the second conducive device includes a movable element configured to be in selective electrical communication with the ground.

20. The material handling container of claim 19, wherein the movable element is retractable to a position at least partially surrounded by at least a portion of the container.
